(19) United States
(12) Patent Application Publication
(10) Pub. No.: US 2005/0037753 A1
(43) Pub. Date: Feb. 17, 2005

(54) Method for a communication device to search for an alternate network upon a registration failure

(76) Inventors: Niels Peter Skov Andersen, Roskilde (DK); Stephen A. Howell, Gloucester (GB); M. R. Ramachandra Srikrishna, Bangalore (IN); Donald A. Dorsey, Vernon Hills, IL (US)

Correspondence Address: MOTOROLA, INC., 1303 EAST ALGONQUIN ROAD, IL01/3RD, SCHAUMBURG, IL, 60196, US

(21) Appl. No.: 10/639,747

(22) Filed: Aug. 12, 2003

(51) Int. Cl. H04Q 7/20

(52) U.S. Cl. 455/435.2; 455/432.1; 455/434

(57) ABSTRACT

A method for a communication device to search for service from an alternate public land mobile network when a public land mobile network rejects a registration message from the communication device includes a first step of having the device roam to a visited public land mobile network (PLMN). A next step includes sending a registration message to the PLMN. A next step includes rejecting the registration message by the PLMN. This rejection can include ignoring the registration or sending an error message back to the device. A next step then includes searching for service from an alternate public land mobile network.

### FIELD OF THE INVENTION

The present invention relates in general to wireless communication devices, and more particularly to a method for a communication device to search for an alternate network upon a registration failure.

### BACKGROUND OF THE INVENTION

As various different types of communication systems have arisen for radiotelephones, it has become beneficial to provide portable and mobile radiotelephone stations and communication devices the ability to operate between these various communication systems. For example, dual-mode phones have been developed that can operate between two radiotelephone systems. In particular, the Global System for Mobile (GSM)/General Packet Radio Service (GPRS) communication system and the Wideband Code Division Multiple Access (WCDMA) communication system are intended to work together in the same mobile terminal equipment operated under a Universal Mobile Telecommunications System (UMTS) environment. Specifically, a communication device can scan for different networks, such as when roaming for example. When roaming, the Third Generation Partnership Project (3GPP) specifications provide for a communication device to perform scans for a public land mobile network (PLMN) other than the one on which it has currently obtained service.

In the GSM/(GPRS networks, the mobile stations are required to perform registration procedures to avail themselves of the subscribed services of the visited PLMN. These procedures basically involve in the mobile station identifying itself to the network so that the network can perform the subscription checks before allowing the mobile user to use their subscribed services. Based on the outcome of the procedures, the mobile station takes appropriate actions and provides the appropriate services to the user. These procedures will have to be performed by the mobile stations, regardless of which ETSI/3GPP standards revision level, the mobile station is compliant to. However, difficulties arise when the mobile station and the network are using different upgrades of the standard.

The GSM standards have been/being upgraded ever since the GSM Phase 1 stage and there have been newer releases of the standards periodically. Although there are provisions in the standards to ensure backward compatibility between mobiles and networks implemented according to different standards versions, there are networks today which are implemented as part of an older standard version which, due to errors in their implementation of the specification requirements, have problems when a mobile which is implemented according to a later version of the standards communicates with them (e.g. Release 99, 3GPP). Given this scenario, the interaction of communications leads to abnormal behaviors by the mobile station, thereby delaying and hampering normal services for the mobile user.

Also, even in a scenario in which the mobile station and the network are compliant to the same standards revision level, there are certain reject causes that the network can use to communicate to the mobile station when the network did not understand the contents of a message that the mobile station sent to the network. In this case, the only actions specified in the standards to handle such a scenario at the mobile station is a suggestion to wait a certain amount of time and then make a re-attempt to send the message, which however is not going to improve the situation in any way as the mobile is going to re-build and re-transmit the exact same message to the network as it sent before. The situations explained above can cause the mobile user to be unable to obtain services from a particular network and yet remain on that network indefinitely rather than seeking service from other networks.

Therefore, the need exists for a method for a communication device to search for service from an alternate public land mobile network when a public land mobile network rejects a registration message from the communication device. There is also a need to provide fast recovery of service to a user when such an error is detected during registration procedures. It would also be of benefit to provide this performance improvement with little or no additional cost.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, and wherein:

FIG. 1 illustrates the interaction between a mobile unit and two networks, in accordance with a first embodiment of the present invention;

FIG. 2 illustrates the interaction between a mobile unit and two networks, in accordance with a second embodiment of the present invention; and

FIG. 3 illustrates a flow chart of method of operation of a mobile unit, in accordance with the present invention.

### DETAILED DESCRIPTION OF THE PREFERRED EMBODIMENT

The present invention provides a method for a communication device to search for service from an alternate public land mobile network when a (visited) public land mobile network rejects a registration message from the communication device. The present invention also provides fast recovery of service to a user when such an error is detected during registration procedures. Additionally, the present invention can be implemented in a communication system with a relatively simple software modification and no additional hardware, therefore limiting any cost penalty.

The solution provided by the present invention is to have the mobile station perform a network reselection (i.e. switch to a different network, if one is present in the area, and attempt to register on it) if any of the following conditions are encountered during a registration attempt: a) rejected with a reject cause which indicates that the network did not understand the message which the communication device sent (i.e. if it is rejected with any of the causes “semantically incorrect message” or “Invalid Mandatory information message” or “message type not existent” or “Information element not existent” or “protocol error unspecified”, b) ignored by the network (i.e. the network fails to respond after a certain number of retransmissions of the message by the communication device). By performing a network selection in accordance with the present invention, it will be possible to provide the user with normal service on another network rather than simply remaining “stuck” on same network which is not providing normal services to the user.

In general, communication networks have a plurality of cells for providing radiotelephone service to a radiotelephone within a corresponding geographic area. Different networks may have overlapping cell coverage within a geographic area. Each cell of a network provides a radio communication coverage area established by fixed site base stations. Each base station is operable to send and receive messages with mobile radiotelephones. As the radiotelephones are mobile, they are required to search for communication networks as they roam between cells and/or communication systems. As networks are found, the radiotelephones attempts to register onto a network according to a predetermined preference list, i.e. if several networks are available, the radiotelephone will attempt to register on the highest priority network on the list. Although, the present invention can be utilized when the communication device is attempting to register on its home network, it is preferred that this solution be used when the mobile station is roaming on a visited PLMN, i.e. not when the communication device is on the user's home PLMN. The reason is that if the user is not obtaining normal services from the user's home PLMN (and is in area where the home PLMN is present), then it is important that the user be aware of this and inform the network operator about the problem for correction.

There are several examples that can be presented showing particular rejections of a registration (or other) message from a communication device to a network. These rejections can be grouped under ignoring of the message or misunderstanding of the message. Specifically, in a first example, a circuit switched Location Update Request message from the communication device is rejected by the network with any of the causes; “Semantically incorrect message” or “Invalid Mandatory information message” or “message type not existent” or “Information element not existent” or “protocol error unspecified”. In a second example, a Location Update procedure fails abnormally due to no responses from the network. In a third example, a Combined GPRS Attach Request message from the communication device is rejected by the network with any of the causes, “Semantically incorrect message” or “Invalid Mandatory information message” or “message type not existent” or “Information element not existent” or “protocol error unspecified”. In a fourth example, a Combined GPRS Attach procedure encounters an abnormal failure due to no responses from the network. In a fifth example, a Combined GPRS Routing Area Update procedure is rejected with any of the causes, “Semantically incorrect message” or “Invalid Mandatory information message” or “message type not existent” or “Information element not existent” or “protocol error unspecified”.

It should be noted that per the current (Release 99) 3GPP specifications, if the mobile encounters any of the above conditions, the mobile would treat it as an abnormal failure and would repeat the procedure (staying on the same network) a specified number of times spaced between small timer intervals. If the mobile reaches the specified number of attempts without success, it would then wait for a longer period of time (as defined by the network), and would re-start the whole procedure again. Therefore, if any of the above conditions is encountered, the communication device should select a different preferred network and perform the registration attempt, in accordance with the present invention, so that the user can have normal services.

In practice, when a mobile station (MS) is switched on or roams to a new network, it attempts to make contact with a Public Land Mobile Network (PLMN). The MS chooses a local cell base station (BS) of the PLMN, in accordance with known techniques, and attempts to register thereon. Typically, the MS and BS 12 initialize and register communication between themselves whereupon the mobile is camped on the base station's network (e.g. GSM or WCDMA) and normal service can commence. However, there are faults in some implementations of older networks wherein the network will ignore registration requests from upgraded radiotelephones, as described previously.

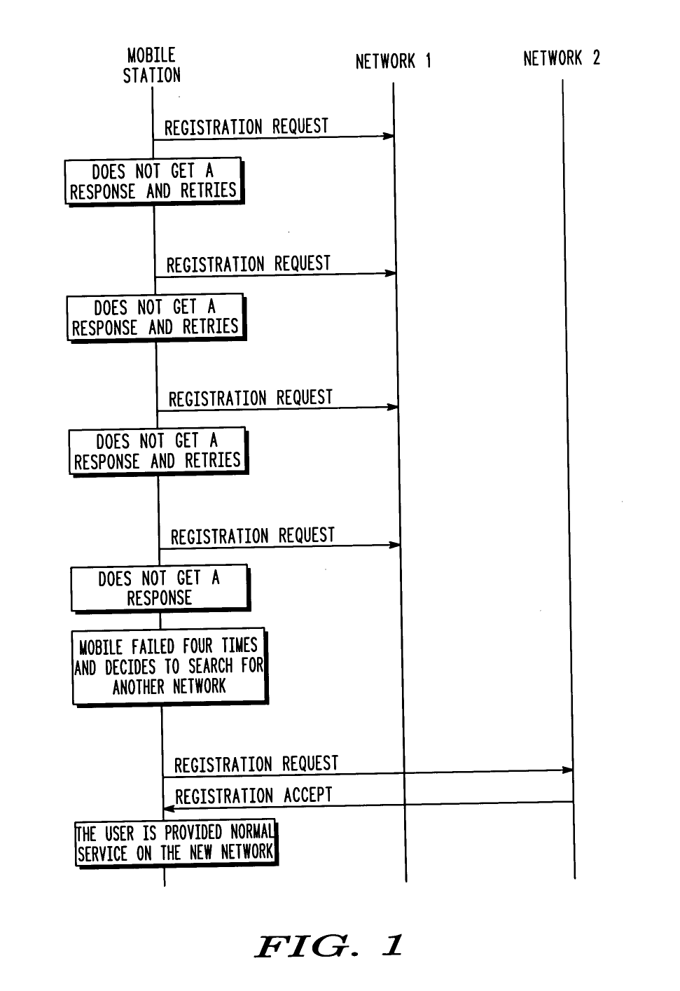

FIG. 1 shows the operation of a communication device, such as a mobile radiotelephone, in accordance with a first embodiment of the present invention, wherein a visited public land mobile network (PLMN) ignores one or more registration requests from the communication device. The registration request itself can take many forms, and can generically be referred to as a Location Registration (LR) or just registration, as will be used herein. For example, in a circuit-switched network the registration procedure can include a registration message in the form of a Location Update (LU) Request sent from the communication device to the (visited) network. In another example, in a packet-switched network the registration procedure can be in a combined form to register both circuit-switched along with packet-switched services. In this case, the registration procedure can include a registration message in the form of a Combined GPRS Attach Request (AR) or a Combined GPRS Routing Area Update (RAU) Request sent from the communication device to the (visited) network.

In operation, referring to FIG. 1, the MS will attempt to obtain service upon a (visited) PLMN by sending a registration request in any of the forms described above. For example, the radiotelephone could send a Location Request of the form LU Request, a combined AR, or a combined RAU. As shown, an older network may not recognize the registration request from an upgraded MS, due to a faulty implementation, and ignore the request. It may be that this is only due to common communication problems. Therefore, the MS will make several attempts to register. However, in accordance with this first embodiment of the invention, the MS will only make a predetermined number of registration attempts before it decides to search for another network. For example, in a circuit-switched application, the MS may only make four attempts to register before it decides to search for another network. In another example, for a combined packet-switched and circuit-switched application, the MS may make up to five attempts to register before it decides to search for another network. Once the MS has decided to terminate its registration attempts, it will search for another network and send a registration request to it, which normally results in the registration being accepted and the network providing registration such that normal service can be provided.

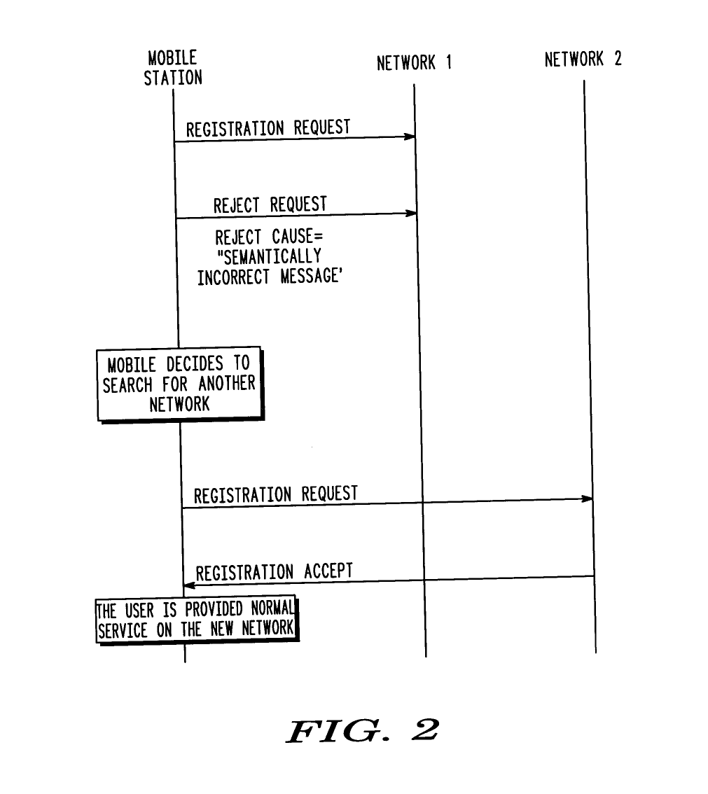

FIG. 2 shows the operation of a communication device, such as a mobile radiotelephone, in accordance with a second embodiment of the present invention, wherein a visited public land mobile network (PLMN) rejects a registration request from the communication device for various rejection causes. In operation, the MS will attempt to obtain service upon a (visited) PLMN by sending a registration message. Once again, the radiotelephone could send a registration message in the form of a LU Request, a combined AR, or a combined RAU. As shown, an older network may not be able to properly interpret the registration request from an upgraded MS, due to a faulty implementation, and reject it for various causes. For example, some of the reject causes can be “semantically incorrect message” (as shown) or “invalid mandatory information message” or “message type not existent” or “information element not existent” or “protocol error unspecified”. In this case, it is not possible that the rejection was only due to common communication problems since it was received by the network, which returned a rejection reason. Therefore, the MS will not retransmit any more registration request messages, and will immediately decide to search for another network. Once the MS has decided to search for another network, the MS will send a registration request message to it, which normally results in the registration being accepted and the network providing registration such that normal service can be provided.

A novel aspect of the present invention is having the communication device decide when a network is faulty and decide to find another network instead of being caught in an indefinite loop of registration attempts. In addition, the communication device can store an identity of the faulty base station or network such that the communication device does not waste time and power trying to register with that same faulty cell or network when roaming. The radiotelephone would save this information in storage, which can be a subscriber identity module or a memory, for example. Preferably, this information would be purged upon the powering-down of the communication device, inasmuch as the implementation of the cells or network can be upgraded at any time.

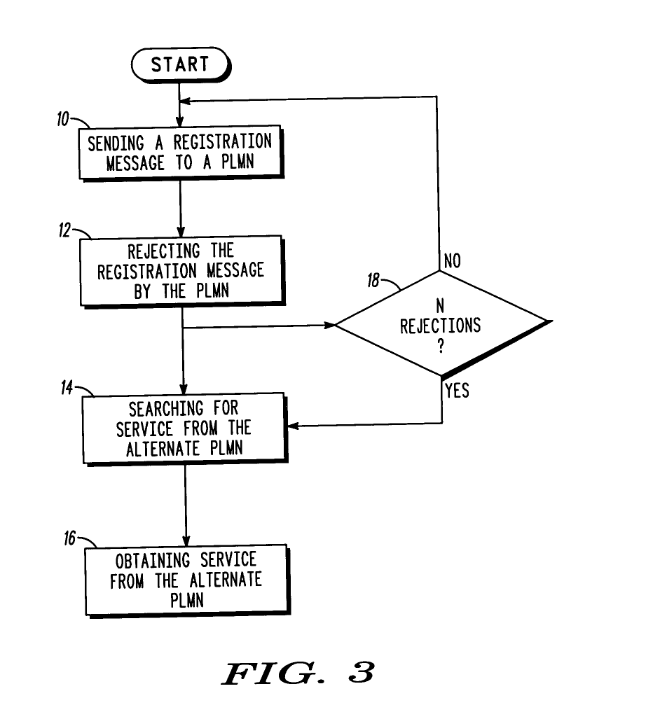

The method of the present invention can be further understood with reference to FIG. 3. The method provides a method for a communication device to decide to search for service from an alternate public land mobile network when a public land mobile network rejects a registration message from the communication device. Each communication network includes a plurality of cells for providing radiotelephone service to a radiotelephone within a corresponding geographic area. Each cell includes paging and voice communication and has a radio communication coverage area established by fixed site base stations, which operate to send messages to radiotelephones and receive messages therefrom. Although applicable to all networks, the method of the present invention finds particular application when roaming on visited PLMNs.

In a first step 10 of the method, the communication device sends a registration message to a public land mobile network, such as a visited PLMN. The registration message is a request that can generically be referred to as a Location Registration (LR) or just registration. For example, in a circuit-switched network, an attempt for registration can include a registration message in the form of a Location Update (LU) Request. In another example, in a packet-switched network the registration procedure can be in a combined form to register both circuit-switched along with packet-switched services. In this case, the registration procedure can include a registration message in the form of a Combined GPRS Attach Request (AR) or a Combined GPRS Routing Area Update (RAU) Request sent from the communication device to the (visited) network.

A next step 12 of the method includes rejecting of the registration message by the public land mobile network. This rejection can take the form of a rejection cause sent by the network to the communication device, or by having the network ignore the registration message from the communication device. The communication device will respond differently to these two types of rejection.

In a first embodiment, the rejecting step can include the communication device receiving a rejection message from the public land mobile network indicating that the public land mobile network did not understand the registration message. Specifically, the rejection message includes at least one reject cause message that is one of the group consisting of “semantically incorrect message”, “invalid mandatory information message”, “message type not existent”, “information element not existent”, and “protocol error unspecified”. These rejection cause messages are presently described in the 3GPP standard, and there may be future rejection cause messages specified that would be equally applicable in the present invention.

In a second embodiment, the rejecting step further comprising the step of determining that the public land mobile network is ignoring the registration message. Initially, the communication device will not know if the ignoring is due to an air interface problem or due to a faulty network implementation. Therefore, it is preferred that the communication device retransmit 18 the registration message a predetermined number of times. Specifically, this includes sending a predetermined number of retransmissions of the registration message by the communication device to the public land mobile network, and determining that the public land mobile network is ignoring the communication device when the public land mobile network fails to acknowledge any of the predetermined number of retransmissions of the registration message sent by the communication device.

A next step 14 includes searching for service from an alternate public land mobile network when the communication device is rejected either through an explicit reject cause or by being ignored by the network. Once an alternate network is found, a last step 16 includes obtaining registration and service from the alternate network.

The present invention provides particular advantage for upgraded communication devices when they roam among networks having older implementations of the communication system standard. These features described above provide a way for a user of a communication device to quickly recover service in these situations while saving battery power. Although the invention has been described in the context of a radiotelephone, it should be recognized that the present invention is equally adept in the context of all radio communication devices including personal digital assistants, computer systems, etc.

While the invention has been described in the context of a preferred embodiment, it will be apparent to those skilled in the art that the present invention may be modified in numerous ways and may assume many embodiments other than that specifically set out and described above. Accordingly, it is intended by the appended claims to cover all modifications of the invention which fall within the broad scope of the invention.

1. A method for a communication device to search for service from an alternate public land mobile network when a public land mobile network rejects a registration message from the communication device, the method comprising the steps of:
sending a registration message to a public land mobile network;
rejecting of the registration message by the public land mobile network; and
searching for service from the alternate public land mobile network.

2. The method of claim 1, wherein the rejecting step includes the communication device receiving a rejection message from the public land mobile network indicating that the public land mobile network did not understand the registration message.

3. The method of claim 2, wherein the rejection message of the rejecting step includes at least one reject cause message of the group consisting of “semantically incorrect message”, “invalid mandatory information message”, “message type not existent”, “information element not existent”, and “protocol error unspecified”.

4. The method of claim 1, wherein after the rejecting step where no message was received further comprising the step of retransmitting the registration message sent by the communication device.

5. The method of claim 1, wherein after the rejecting step where no message was received further comprising the step of determining that the public land mobile network is ignoring the registration message.

6. The method of claim 1, wherein after the rejecting step where no message was received further comprising the steps of:
sending a predetermined number of retransmissions of the registration message by the communication device to the public land mobile network, and
determining that the public land mobile network is ignoring the communication device when the public land mobile network fails to acknowledge any of the predetermined number of retransmissions of the registration message sent by the communication device.

7. The method of claim 1, wherein the registration message of the sending step includes one of the group of a location update request, a GPRS attach request, and a GPRS routing area update.

8. A method for a communication device to search for service from an alternate public land mobile network when a visited public land mobile network rejects a registration message from the communication device, the method comprising the steps of:
roaming to a coverage area of a visited public land mobile network
sending a registration message to the visited public land mobile network;
receiving a message from the visited public land mobile network indicating that the visited public land mobile network did not understand the registration message; and
searching for service from the alternate public land mobile network.

9. The method of claim 8, wherein the rejection message of the rejecting step includes at least one reject cause message of the group consisting of “semantically incorrect message”, “invalid mandatory information message”, “message type not existent”, “information element not existent”, and “protocol error unspecified”.

10. The method of claim 8, wherein after the receiving step where no message was received further comprising the step of retransmitting the registration message sent by the communication device.

11. The method of claim 8, wherein the registration message of the sending step includes one of the group of a location update request, a GPRS attach request, and a GPRS routing area update.

12. A method for a communication device to search for service from an alternate public land mobile network when a visited public land mobile network rejects a registration message from the communication device, the method comprising the steps of:
roaming to a coverage area of a visited public land mobile network
sending a registration message to the visited public land mobile network;
ignoring of the registration message by the visited public land mobile network; and
searching for service from the alternate public land mobile network.

13. The method of claim 12, wherein after the ignoring step further comprising the step of retransmitting the registration message sent by the communication device.

14. The method of claim 12, wherein after the ignoring step further comprising the steps of:
sending a predetermined number of retransmissions of the registration message by the communication device to the visited public land mobile network, and
determining that the visited public land mobile network will not acknowledge the communication device when the visited public land mobile network fails to acknowledge any of the predetermined number of retransmissions of the registration message sent by the communication device.

15. The method of claim 12, wherein the registration message of the sending step includes one of the group of a location update request, a GPRS attach request, and a GPRS routing area update.
